(19) United States
(12) Patent Application Publication
(10) Pub. No.: US 2024/0167837 A1
(43) Pub. Date: May 23, 2024

(54) DISPLAY PROCESSING APPARATUS, MOVABLE APPARATUS, AND DISPLAY PROCESSING METHOD

(71) Applicant: CANON KABUSHIKI KAISHA, Tokyo (JP)

(72) Inventors: MINORU OHKOBA, Chiba (JP); JUNYA YOKOYAMA, Tokyo (JP); TAKAYUKI KIMURA, Kanagawa (JP); TOSHIYA TAKAHASHI, Kanagawa (JP); MAKOTO TAKAHASHI, Tochigi (JP); TADANORI SAITO, Tokyo (JP)

(21) Appl. No.: 18/500,315

(22) Filed: Nov. 2, 2023

(30) Foreign Application Priority Data
Nov. 18, 2022 (JP) 2022-185311

(51) Int. Cl. G01C 21/36; B60R 1/24

(52) U.S. Cl. CPC G01C 21/3638; B60R 1/24; G01C 21/3647; G01C 21/365; G01C 21/3661; B60R 2300/207; B60R 2300/50; B60R 2300/802; B60R 2300/806

(57) ABSTRACT

A display processing apparatus includes a memory storing instructions, and a processor that executes the instructions to display a guidance image configured to guide a route to a destination area for a user, in a display area superimposed on an external world so that the guidance image is superimposed on the external world, acquire three-dimensional information on an object existing between the user and the destination area after the user specifies the destination area in a captured image of a location including the destination area, and generate, using the three-dimensional information, the guidance image including a shielded area image that displays the route and the destination area that are respectively shielded from the user by the object.

### BACKGROUND

### Technical Field

One of the aspects of the embodiments relates to a navigation technology that guides a route to a destination.

### Description of Related Art

Some navigation apparatuses for guiding a route to a destination for drivers of vehicles such as automobiles and motorcycles use a head-up display that displays a guidance image such as a route guidance arrow in a display area that can see-through-display a route such as a road in the external world of the vehicle. Since the guidance image is superimposed on the route in the external world, the driver can check the route while viewing the external world.

In a case where an arrow indicating a turn, such as a left turn ahead of the road sign in the external world viewable through the display area is superimposed on the road sign, the apparatus disclosed in Japanese Patent Laid-Open No. 2018-173399 does not display an arrow portion superimposed on the sign and facilitates understanding that the turning position is located ahead of the sign.

However, a driver may not be able to view a post-turn route or destination due to buildings or other obstructions. In this case, the driver has difficulty in checking whether or not he is to actually turn according to the arrow displayed in the display area, and consequently may not be able to smoothly turn or may go past the turning position.

### SUMMARY

A display processing apparatus according to one aspect of the embodiment includes a memory storing instructions, and a processor that executes the instructions to display a guidance image configured to guide a route to a destination area for a user, in a display area superimposed on an external world so that the guidance image is superimposed on the external world, acquire three-dimensional (3D) information on an object existing between the user and the destination area after the user specifies the destination area in a captured image of a location including the destination area, and generate, using the three-dimensional information, the guidance image including a shielded area image that displays the route and the destination area that are respectively shielded from the user by the object. A movable apparatus, a wearable apparatus, or a terminal device having the above display processing apparatus also constitutes another aspect of the embodiment. A display processing method corresponding to the above display processing apparatus also constitutes another aspect of the embodiment.

Further features of the disclosure will become apparent from the following description of embodiments with reference to the attached drawings.

### BRIEF DESCRIPTION OF THE DRAWINGS

FIG. 1 is a block diagram illustrating a configuration of a navigation system including a display processing apparatus according to a first embodiment.

FIG. 2 is a conceptual diagram illustrating the used state of the above system.

FIG. 3 illustrates a display example of the conventional display processing apparatus.

FIG. 4 illustrates a display example of a display processing apparatus according to this embodiment.

FIG. 5 illustrates another display example of this embodiment.

FIG. 6 illustrates still another display example of this embodiment.

FIGS. 7A, 7B, 7C, 7D, and 7E illustrate other display examples of this embodiment.

FIG. 8 is a flowchart illustrating processing according to a first embodiment.

FIG. 9 is a flowchart illustrating processing according to a second embodiment.

FIGS. 10A and 10B illustrate variations of an apparatus including the display processing apparatus.

FIG. 11 illustrates a method of specifying a destination area (target area) in a captured image on a terminal device.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments.

### First Embodiment

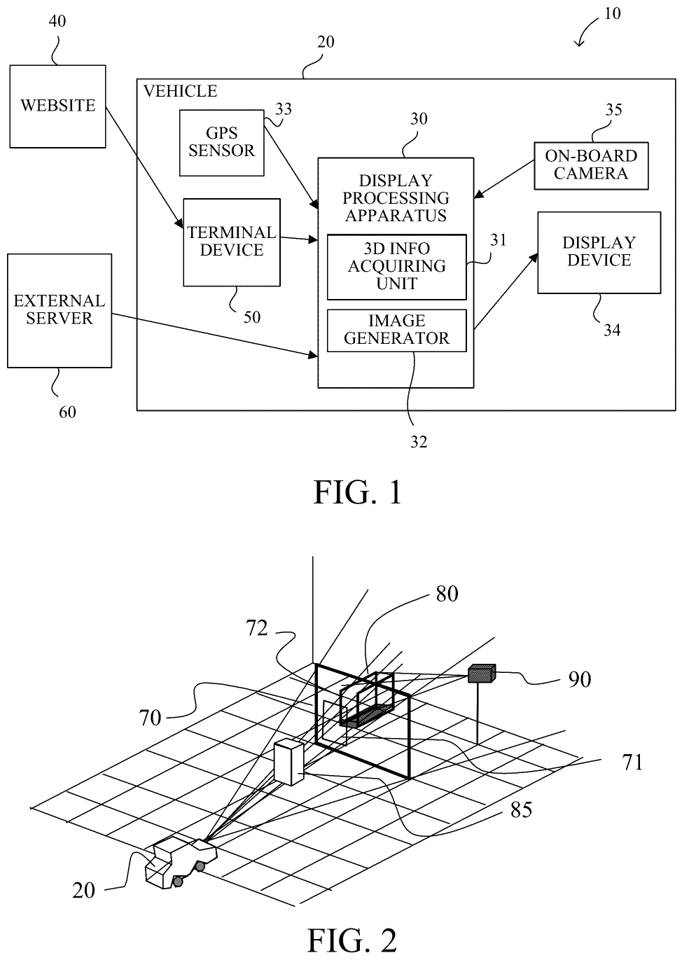

FIG. 1 illustrates the configuration of a navigation system 10 including a display processing apparatus 30 according to a first embodiment. The navigation system 10 includes the display processing apparatus 30, a GPS sensor 33, a display device 34, and an on-board (or in-vehicle) camera 35 each mounted on an automobile (vehicle) 20 as a movable apparatus.

The GPS sensor 33 acquires self-location information on an automobile 20 (that is, a driver as a user) and inputs it into the display processing apparatus 30.

The display device 34 is a head-up display that projects and displays a guidance image, which will be described below, on a display area set so that the display area is superimposed on the external world on the windshield of the automobile 20 through which the external world of the vehicle can be viewed. The driver can view the displayed guidance image while viewing the outside of the vehicle (external world) through the windshield. Thereby, the driver can drive the automobile 20 while viewing the guidance image superimposed on the route, such as a road, in the external world and provided with route guidance. The display device 34 may use one that projects and displays a guidance image onto a display area set on a transparent member placed between the windshield and the driver so that the display area is superimposed on the external world.

The on-board camera 35 moves together with the automobile 20 (that is, the driver) and images the external world. The imaging angle of view of the on-board camera 35 is set in accordance with the driver's field of view (FOV) relative to the external world. The external world image obtained by the on-board camera 35 is used to set the position, size, etc. of the display area on the windshield of the guidance image by the display device 34.

The navigation system 10 is used by a driver who downloads captured images of various locations viewable on websites on the Internet into a terminal device 50 such as a smartphone or a tablet computer. The captured images include images captured by an external camera (such as a surveillance camera, and cameras installed on an aircraft and satellite). The driver can specify as a region of interest (ROI) a destination area (such as a parking lot) toward which the automobile 20 is heading from among locations (such as the entire facility represented by one address) included in the captured image downloaded by the terminal device 50. Information such as the position (coordinates) and shape of the designated destination area is input from the terminal device 50 to the display processing apparatus 30 through communication using Bluetooth (registered trademark) or the like.

The display processing apparatus 30 can acquire three-dimensional map data of the above various locations stored in the external server 60 via communication. The three-dimensional map data can use, for example, data published as a three-dimensional city model by Project PLATEAU (trademark) in Japan.

The display processing apparatus 30 includes a computer (such as an Electronic Control Unit (ECU)) including at least one processor, memory, etc., and has a three-dimensional information acquiring unit 31 as an information acquiring unit and an image generator 32 as an image processing unit. The three-dimensional information acquiring unit 31 specifies a building, a signboard, and another object existing between the automobile 20 and the destination area on the three-dimensional map data based on the user's position information obtained from the GPS sensor 33 and the position information on the destination area. The three-dimensional information on the specified object is acquired from the three-dimensional map data.

The image generator 32 generates a guidance image. The guidance image includes a visible area image that is displayed and superimposed on the route viewable by the driver in the external world, and a shielded area image that is displayed and superimposed on the object so as to indicate a route or destination area that is shielded by an object (shield or obstruction) and is not visible to the driver. The image generator 32 generates a shielded area image based on the three-dimensional information on the shield acquired by the three-dimensional information acquiring unit 31.

The image generator 32 detects the route and shields in the external world image acquired by the on-board camera 35 by template matching, AI processing using a machine learning model, etc. The display position and display size of the visible area image and the shielded area image on the display area (windshield) by the display device 34 are set in accordance with these positions and sizes.

FIG. 2 conceptually illustrates how the navigation system 10 according to this embodiment is used. FIG. 2 illustrates a relationship between a surface imaged by the on-board camera 35, that is, a surface viewed by the driver (referred to as an FOV surface hereinafter) 70, a destination area 80, and an object 85. The FOV surface 70 is located between the destination area 80 (having a three-dimensional shape in this example) and the object 85 closer to the automobile 20.

As illustrated in FIG. 2, in a case where the object 85 exists as a shield between the automobile (user's vehicle) 20 and the destination area 80, the driver cannot directly see the destination area 80 and the route around it. On the other hand, a location including the destination area 80 and its surroundings is imaged by an external camera 90, and the driver can confirm and specify the destination area 80 in the captured image. Therefore, once the position of the user's vehicle (user's position information), information on the position and shape of the destination area 80 specified in the captured image, and three-dimensional information (information on the position and three-dimensional shape) of the object 85 are known, it can be determined whether or not the destination area 80 is blocked (invisible) by the object 85 as the shield for the user.

In a case where the object 85 is determined to be the shield, a shielded area image is displayed as a guidance image illustrating a map 75 of the destination area 80 and a map of the nearby route so that the shielded area image is superimposed on the map 71 of the object 85 in the display area corresponding to the FOV surface 70. Thereby, the driver can visually recognize the destination area 80 and the nearby route.

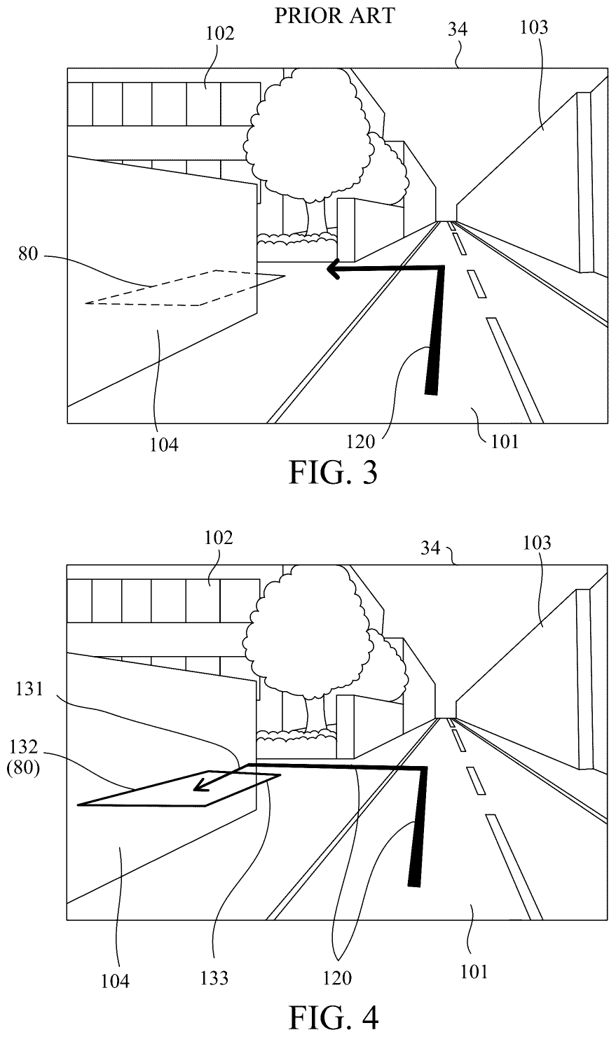

FIGS. 3 to 6 illustrate examples of guidance images displayed by the display device 34. FIGS. 3 to 6 illustrate the vicinity of the destination area 80 where a distance to the destination area 80 is less than a predetermined distance, which the driver views the route (road) 101 in the external world and the surrounding facilities 102 and 103 through the windshield (the external world image from the board camera 35).

As illustrated by the broken line in FIG. 3, the destination area 80 is a parking lot near the entrance of the site of the facility 102, and most of it is hidden by a wall 104 of the facility 102. Conventionally, as illustrated in FIG. 3, an arrow image (visible area image) 120 as a guidance image is superimposed and displayed only on the route 101 that is visible to the driver in the display area. However, it is difficult for a driver who can hardly view the destination area 80 to check whether or not he is actually allowed to turn according to the arrow image 120 and enter from the entrance of the facility 102. As a result, he is likely to go past the entrance, or the destination area 80 near the wall 104 even if the user enters through the entrance.

On the other hand, FIG. 4 according to this embodiment displays and superimposes an arrow image (shielded area image) 131 for guiding the route to the destination area 80 on the wall 104, and also displays and superimposes a frame image (shielded area image) 132 indicating the destination area 80 on the wall 104. Thereby, the driver can enter through the entrance of facility 102 and be confident that he should park in the parking lot near the wall 104.

By starting to display the arrow image 131 and the frame image 132 before the user turns (turns left) near the destination area 80, the driver can be smoothly guided to the destination area 80 without hesitation as to whether or not he is allowed to turn. In particular, the arrow image 131 and the frame image 132 may be displayed before the user turns multiple times near the destination area 80.

The colors of the wall 104 and surroundings may be detected from the external world image from the on-board camera 35, and the arrow image 131 and the frame image 132 may be displayed in colors different from the colors of the wall 104 and surroundings. For example, the arrow image 131 and the frame image 132 may be displayed in complementary colors to the average color of the surroundings of the wall 104 and others.

FIG. 4 illustrates the arrow image 131 so as to connect it with the arrow image 120 and to provide the route guidance without making the driver feel uncomfortable. The arrow image 131 may be displayed so that it is not connected with the arrow image 120 as long as the driver does not feel uncomfortable.

FIG. 4 highlights the part of the destination area 80 that is visible to the driver by a frame image (visible area image) 133 connected with the frame image 132. Thereby, the driver can recognize the entire destination area 80 including the part visible to the driver.

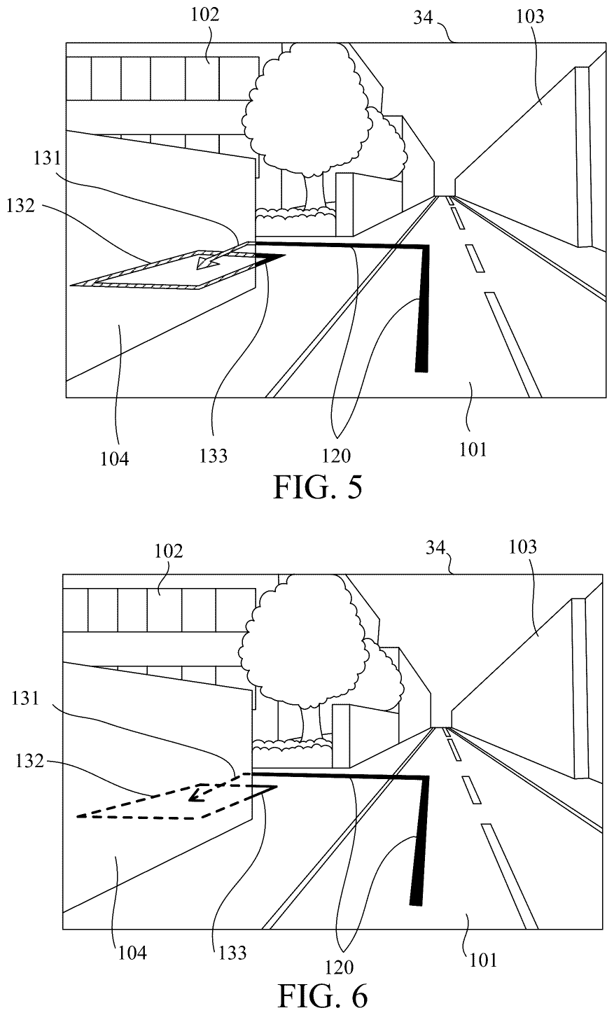

FIGS. 5 and 6 illustrate a modification to FIG. 4. In FIG. 4, the display form (color, line type, etc.) of each of the arrow image 131 and the frame image 132 is the same as that of the arrow image 120. On the other hand, the display form of each of the arrow image 131 and the frame image 132 may be different from that of the arrow image 120.

In FIG. 5, the color of each of the arrow image 131 and the frame image 132 is different from that of the arrow image 120. The arrow image 131 and the frame image 132 may be displayed with double lines without filling. In FIG. 6, the arrow image 131 and the frame image 132 are indicated by dashed lines to differ from the arrow image 120 indicated by solid lines. Thereby, the driver can clearly recognize that the route and the destination area 80 indicated by the arrow image 131 and the frame image 132 are not actually visible.

In FIGS. 5 and 6, the frame image 133, which is the visible area image, is displayed in the same manner as the arrow image 120, which is also the visible area image, but the display form of the frame image 133 may be the same as that of a certain frame image 132.

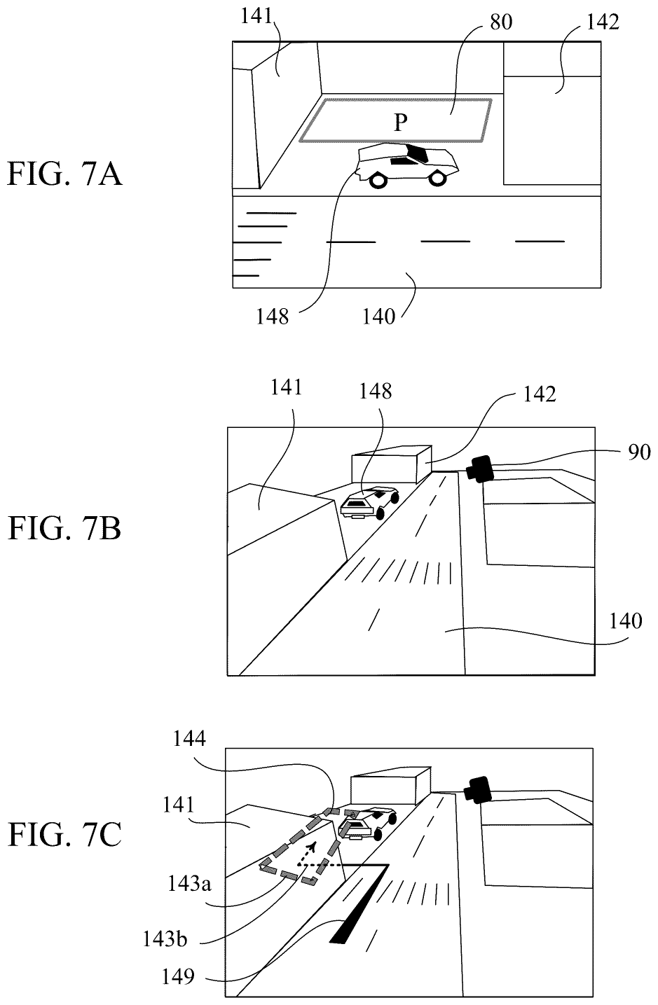

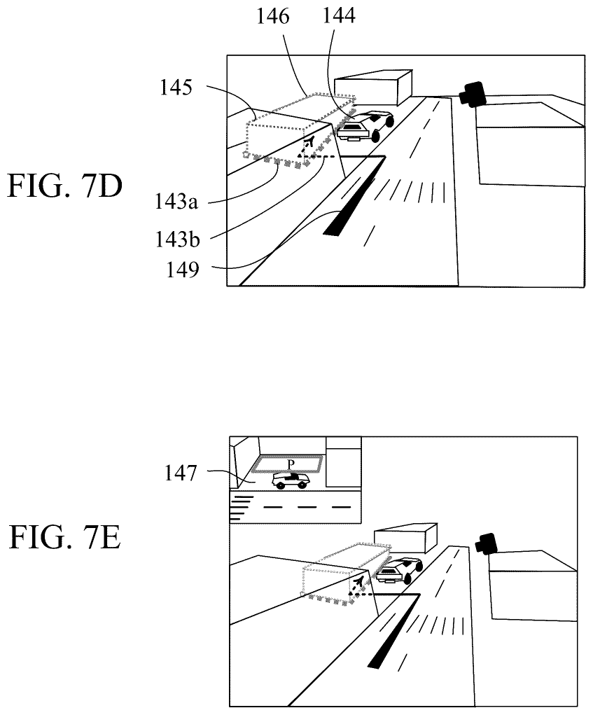

FIGS. 7C, 7D, and 7E illustrate display examples of the destination area 80 (parking lot P) by the display device 34. FIGS. 7C, 7D, and 7E omit an arrow image for route guidance to the destination area 80.

FIG. 7A illustrates a captured image obtained by the external camera (surveillance camera) 90 set on the opposite side of the road 140 from the destination area 80, as illustrated in FIG. 7B. The destination area 80 is located between two buildings 141 and 142 built along the road 140 and is separated from the road 140 by one parking lot. Thus, most of the destination area 80 is difficult to see from the user's vehicle approaching from the front in FIG. 7A, as it is blocked by the building 141 (and the automobile 148 already parked in the parking lot on the roadside).

FIG. 7C illustrates a display example that superimposes on the building 141a broken-line frame image (shielded area image) 143a illustrating the destination area 80 that is invisible due to the building 141, and a broken-line arrow image (shielded area image) 143b indicating the route to the destination area 80 that is also invisible due to the building 141. FIG. 7C illustrates the visible part of the destination area 80 as a broken-line frame image (visible area image) 144 connected with the frame image 143a as the invisible part, and the visible part of the route as a solid-line arrow image (visible area image) 149a connected to the arrow image 143b.

Similarly to FIG. 7C, FIG. 7D illustrates an example that displays and superimposes the broken-line frame image 143a and the arrow image 143b on the building 141 and a solid-line frame image 144. Even this example displays the arrow image 149. In FIG. 7D, a dotted-line stereoscopic image (shielded area image) 145 illustrating a portion of the three-dimensional shape (rectangular parallelepiped shape herein) of the destination area 80 as the parking lot that is invisible by the building 141 is displayed and superimposed on the building 141, and a visible portion is displayed as a solid-line stereoscopic image (visible area image) 146. Due to such a display, the driver can stereoscopically recognize the destination area 80.

Similarly to FIG. 7D, FIG. 7E illustrates an example that displays frame images 143a to 146, and a captured image 147 in FIG. 7A acquired by the external camera 90 as Picture-in-Picture (PIP) display. By displaying the captured image 147, the driver can reach the destination area 80 while clearly recognizing the actual shape of the destination area 80 and the positional relationship among the buildings 141 and 142 and the automobile 148.

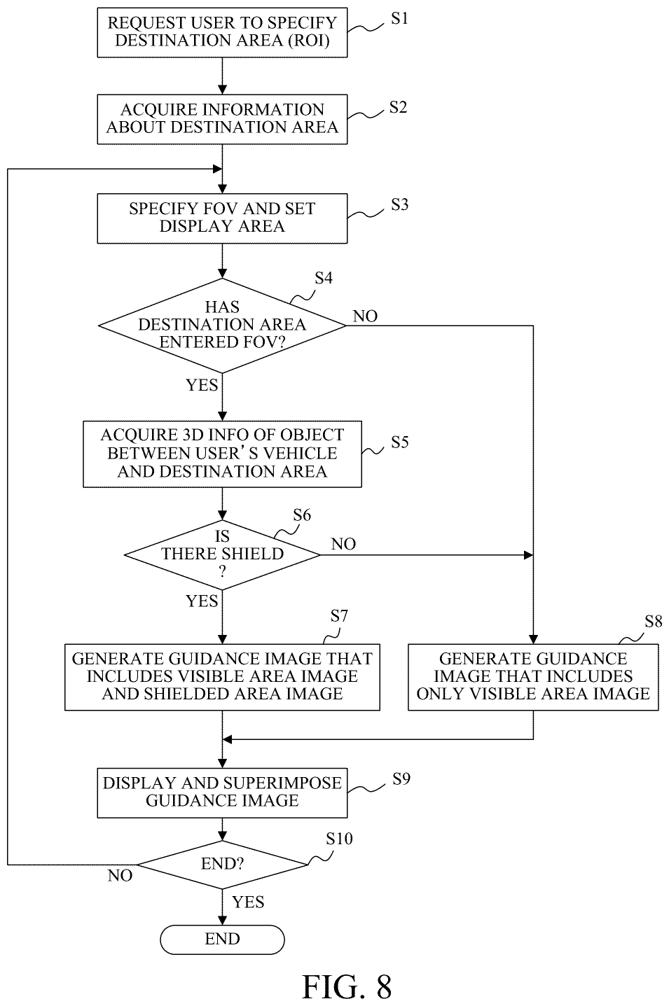

A flowchart in FIG. 8 illustrates the processing (display processing method) executed by the display processing apparatus 30 according to a program.

A program (application) illustrated in FIG. 11 is installed in the terminal device 50. This program includes step S31 of acquiring a captured image (see FIG. 7A) on a website 40 through the Internet, step S32 of causing the user to specify a destination area in the captured image by finger touch or the like, and step S33 of transmitting information on the specified destination area to the display processing apparatus 30.

In step S1 of FIG. 8, the display processing apparatus 30 communicates with the terminal device 50 and requests the driver to specify a destination area. Then, in a case where the destination area is specified by the driver in step S2, information on the destination area is acquired from the terminal device 50.

Next, in step S3, the image generator 32 identifies a field of view (FOV) that is estimated to be viewed by the driver based on the imaging angle of view of the on-board camera 35 and the external world image and sets the position and size of the display area where the display device 34 can display the guidance image according to the field of view.

Next, in step S4, the image generator 32 determines whether or not the destination area enters the field of view based on the user's vehicle position information from the GPS sensor 33 and the field of view information specified in step S3. Here, the “destination area enters the field of view” means that the destination area is included in the field of view of the user's vehicle on the two-dimensional map, regardless of whether the destination area is actually visible to the driver. In a case where the destination area enters the field of view, the flow proceeds to step S5, and in a case where the destination area does not enter the field of view, the flow proceeds to step S8.

Next, in step S5, the three-dimensional information acquiring unit 31 acquires from the above three-dimensional map data three-dimensional information on an object existing between the user's vehicle position and the destination area position that can be specified from the user's vehicle position information and the destination area position information from the GPS sensor 33, respectively.

Next, in step S6, the image generator 32 determines whether an object existing between the user's vehicle and the destination area is a shield that makes the destination area invisible to the driver, based on the user's vehicle position information, the position and shape information on the destination area, and the three-dimensional information acquired in step S5. More specifically, for example, whether or not the object is a shield is determined by checking the space ID of a voxel of the object that can be acquired from the three-dimensional information. In a case where the object is the shield, the flow proceeds to step S7; in a case where the object is not the shield, the flow proceeds to step S8.

In step S7, the image generator 32 generates a guidance image that includes a visible area image to be displayed on the route that is illustrated in the external world image from the on-board camera 35 (visible to the driver) and a shielded area image that displays a route and a destination area that is not illustrated in the external world image (invisible to the driver). Then, the flow proceeds to step S9. At this time, the destination area may be displayed in the visible area image, or only one of the route and the destination area may be displayed in the shielded area image. As described with reference to FIGS. 5 and 6, the visible area image and the shielded area image may have different display forms.

On the other hand, in step S8, the image generator 32 generates a guidance image of only the visible area image to be displayed on the route illustrated in the external world image from the on-board camera 35. Then, the flow proceeds to step S9. Again, the destination area may be displayed using the visible area image.

In step S9, the image generator 32 displays the guidance image generated in step S7 or S8 in the display area through the display device 34.

Next, in step S10, the image generator 32 determines whether or not to end the display of the guidance image. More specifically, the image generator 32 determines whether or not the user's vehicle has approached the destination area based on the user's vehicle position information from the GPS sensor 33. In a case where the display of the guidance image is to end because the user's vehicle has approached the destination area, this flow ends; otherwise, the flow returns to step S3.

This embodiment can display the destination area and route that are not visible to the driver due to a shield and thus can provide route guidance that is easier for the driver to understand.

In this embodiment, three-dimensional information on an object is acquired from three-dimensional map data and it is determined whether the object is a shield. On the other hand, in a case where the user's vehicle has a function of detecting a three-dimensional object using Light Detection and Ranging (LIDAR), etc., a three-dimensional structure of an object that exists between the user's vehicle and the destination area may be acquired as three-dimensional information using the above function. Then, by using the projection transformation of this three-dimensional structure into the display area, whether the object shields the destination area may be determined.

In an image captured by the external camera, a final destination area may be specified as at least one relay point between a departure point and the destination area (such as a parking lot for taking a break or checking the destination near an expressway exit). In this case, a shielded area image can be displayed near the relay point and near the final destination area.

A shielded area image may be displayed according to the constraint condition on the entry into the destination area. For example, in a case where the destination area is a parking lot, the shielded area image may be displayed so as to provide route guidance (parking guidance) based on forward and backward parking restrictions, restrictions on the vehicle size that can be parked, and restrictions from the sizes and situations of the vehicles parked in the adjacent parking lots.

### Second Embodiment

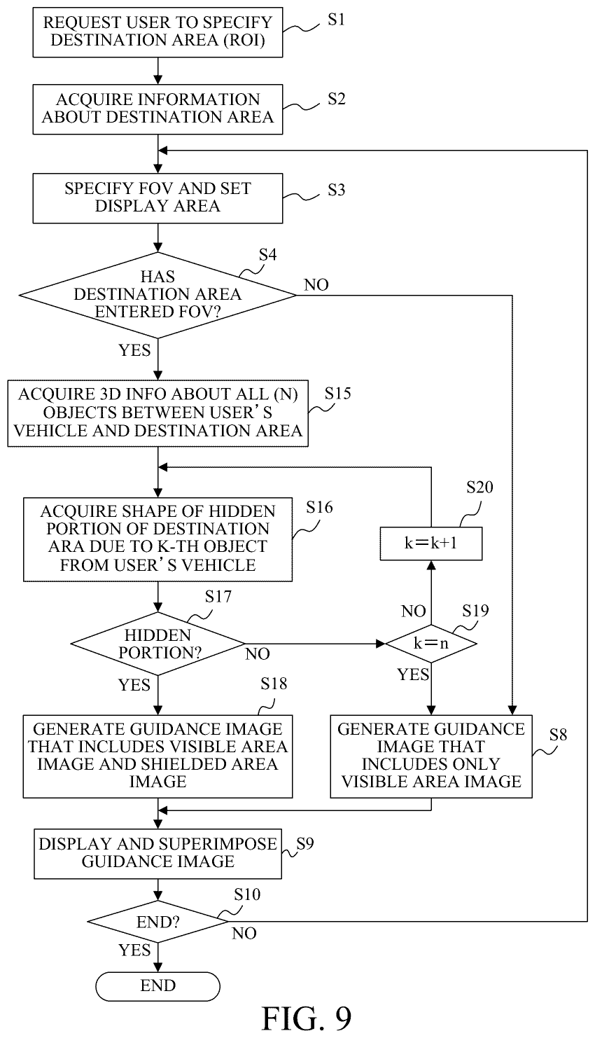

A description will now be given of a second embodiment. A flowchart in FIG. 9 illustrates the processing that the display processing apparatus 30 executes according to a program in the second embodiment. In this embodiment, steps S1-S4 are the same as steps S1-S4 in the first embodiment (FIG. 8). A description will be given of a case where a plurality of objects exist between the user's vehicle and the destination area.

In a case where the display processing apparatus 30 determines that the destination area enters the field of view in step S4, the flow proceeds to step S15. In step S15, the three-dimensional information acquiring unit 31 acquires three-dimensional information on each of a plurality of (n) objects that exist between the user's vehicle position and the destination area position, which can be specified from the user's vehicle position information from the GPS sensor 33 and the position information on the destination area.

In the next step S16, the image generator 32 acquires information on the shape of the portion of the destination area that is shielded (hidden) by the k-th (k=1 to n) object from the user's vehicle side. Information on the shape of the shielded portion can be acquired using the user's vehicle position information, the position and shape information on the destination area, and the three-dimensional information acquired in step S5.

Next, in step S17, the image generator 32 determines whether or not there is a part hidden by the k-th object in the destination area in step S16 (that is, the object is a shield), and in a case where there is that part, the flow proceeds to step S18; otherwise, the flow proceeds to step S19.

In step S18, the image generator 32 generates a guidance image that includes a visible area image to be displayed on the route in the external world image from the on-board camera 35 and a shielded area image to be displayed and superimposed on the k-th object (shield). Then, the flow proceeds to step S9.

On the other hand, in step S19, the image generator 32 determines whether or not k is n. In a case where k is n, the flow proceeds to step S8; in a case where k is not n, the flow proceeds to step S20 to increment k by 1. Then, the flow returns to step S16.

In step S8, the image generator 32 generates a guidance image of only the visible area image to be displayed on the route illustrated in the external world image from the on-board camera 35, similarly to step S8 of the first embodiment. Then, the flow proceeds to step S9.

In step S9, the image generator 32 displays the guidance image generated in step S21 or S8 on the display area through the display device 34, similarly to step S9 of the first embodiment. In step S10, similarly to step S10 of the first embodiment, it is determined whether or not to end the display of the guidance image. If not, the flow returns to step S3, and if it does, the flow ends.

Thus, in a case where there are a plurality of objects between the user's vehicle and the destination area, this embodiment determines whether the object is a shield in order from the object closest to the user's vehicle. Then, this embodiment displays and superimposes the shielded area image on the object that is determined to be a shield first among the plurality of objects, and displays only the visible area image if none of the objects is a shield.

Even if the driver cannot view the destination area or route due to any one of shields among the plurality of objects between the user's vehicle and the destination area, this embodiment can display them. Thereby, this embodiment can provide route guidance that can be easily understood by the driver.

In each of the above embodiments, the display processing apparatus is installed in an automobile, but it may also be installed in various movable apparatuses other than automobiles (such as a ship and aircraft).

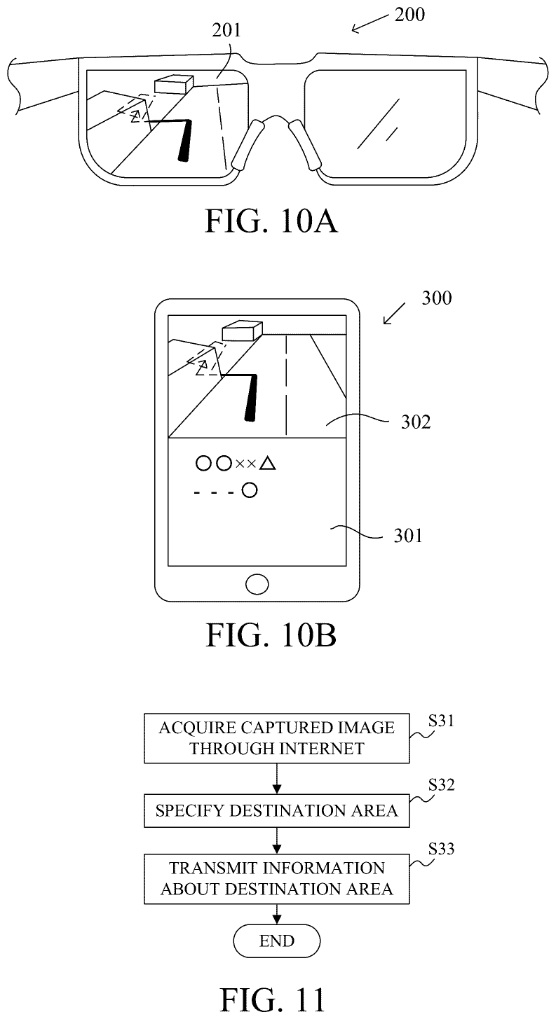

The display processing apparatus may be installed in a wearable apparatus that a user wears in front of his eyes, such as a glasses-type device using the augmented reality (AR) technology. As illustrated in FIG. 10A, a guidance image is displayed in a display area set on a lens 201 placed in front of the user's eyes in a wearable apparatus 200 so that the display area is superimposed on the external world.

Each of the above embodiments has discussed a guidance image displayed and superimposed on the external world in a display area that is superimposed on the actual external world. However, the superimposition on the external world is not limited to superimposition on the actual external world but also includes superimposition on an external world image of the vehicle generated by imaging. That is, as illustrated in FIG. 10B, a display area 302 may be set on a screen 301 of a terminal device 300 such as a smartphone or tablet so that the display area 302 is superimposed on the external world image, and a guidance image may be displayed in the display area 302 so that the guidance image is superimposed on the external world image.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment can provide route guidance that can be easily understood by a user even if the user cannot view the route or destination area due to a shield.

This application claims the benefit of Japanese Patent Application No. 2022-185311, filed on Nov. 18, 2022, which is hereby incorporated by reference herein in its entirety.

What is claimed is:

1. A display processing apparatus comprising:
a memory storing instructions; and
a processor that executes the instructions to:
display a guidance image configured to guide a route to a destination area for a user, in a display area superimposed on an external world so that the guidance image is superimposed on the external world,
acquire three-dimensional information on an object existing between the user and the destination area after the user specifies the destination area in a captured image of a location including the destination area, and
generate, using the three-dimensional information, the guidance image including a shielded area image that displays the route and the destination area that are respectively shielded from the user by the object.

2. The display processing apparatus according to claim 1, wherein the processor is configured to generate the guidance image including the shielded area image and a visible area image that is displayed and superimposed on a route that is not shielded by the object.

3. The display processing apparatus according to claim 2, wherein the processor is configured to make different a display form of the shielded area image from that of the visible area image.

4. The display processing apparatus according to claim 1, wherein the processor is configured to specify the object on three-dimensional map data and to acquire the three-dimensional information from the three-dimensional map data.

5. The display processing apparatus according to claim 1, wherein the processor is configured to determine whether the object shields the route and the destination area using the three-dimensional information, and to generate the guidance image including the shielded area image if determining that the object shields the route and the destination area.

6. The display processing apparatus according to claim 5, wherein the processor is configured to determine whether the object shields the route and the destination area using a space ID of a voxel representing the object as the three-dimensional information.

7. The display processing apparatus according to claim 5, wherein the processor has a function of detecting a three-dimensional object and is configured to:
acquire information on a three-dimensional structure of the object as the three-dimensional information using the function, and
determine whether the object shields the route and the destination area through projection transformation of the information about the three-dimensional structure onto the display area.

8. The display processing apparatus according to claim 5, wherein in a case where there are a plurality of objects between the user and the destination area, the processor is configured to determine whether the object shields the route and the destination area in order from an object closest to the user.

9. The display processing apparatus according to claim 1, wherein the processor is configured to generate the guidance image including the shielded area image that corresponds to a constraint condition on entry into the destination area.

10. The display processing apparatus according to claim 1, wherein the processor is configured to set a display position and display size of the guidance image using an image of the external world captured by an image pickup apparatus that is movable with the user.

11. The display processing apparatus according to claim 1, wherein the captured image is viewable on a terminal device of the user through the Internet, and the processor is configured to acquire information on the destination area specified on the terminal device, from the terminal device through communication.

12. A movable apparatus comprising the display processing apparatus according to claim 1,
wherein the guidance image is displayed to the user who rides the movable apparatus.

13. The movable apparatus according to claim 12, wherein the guidance image is displayed in the display area set on a windshield of the movable apparatus.

14. A wearable apparatus comprising the display processing apparatus according to claim 1,
wherein the wearable apparatus is attached to the user in front of an eye of the user, and configured to display the guidance image in the display area set on a lens of the wearable apparatus.

15. A terminal device comprising the display processing apparatus according to claim 1,
wherein the guidance image is displayed so that the guidance image is superimposed on an image of the external world displayed on the terminal device.

16. A display processing method comprising the steps of:
displaying a guidance image configured to guide a route to a destination area for a user, in a display area superimposed on an external world so that the guidance image is superimposed on the external world,
acquiring three-dimensional information on an object existing between the user and the destination area after the user specifies the destination area in a captured image of a location including the destination area, and
generating, using the three-dimensional information, the guidance image including a shielded area image that displays the route and the destination area that are respectively shielded from the user by the object.

17. A non-transitory computer-readable storage medium storing a program that causes a computer to execute the display processing method according to claim 16.

18. A non-transitory computer-readable storage medium storing a program installed in the terminal device for the display processing apparatus according to claim 11, the program causing the terminal device to execute a method that includes the steps of:
acquiring the captured image viewable through the Internet; and
transmitting the information about the destination area to the display processing apparatus after the user specifies the destination area included in the captured image on the terminal device.
